(19) United States
(12) Patent Application Publication
(10) Pub. No.: US 2002/0067526 A1
(43) Pub. Date: Jun. 6, 2002

(54) Bi-directional optical add/drop multiplexer

(76) Inventors: Heuk Park, Taejon (KR); Kwang Joon Kim, Taejon (KR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/816,805

(22) Filed: Mar. 23, 2001

(30) Foreign Application Priority Data
Dec. 5, 2000 (KR) 2000-73338

(51) Int. Cl. H04J 14/02

(52) U.S. Cl. 359/127; 359/124

(57) ABSTRACT

The present invention relates to a bi-directional optical add/drop multiplexer used in a bi-directional optical transmission system. The bi-directional optical add/drop multiplexer comprises circulators, optical amplifiers, drop filters, add filters and optical isolators and is capable of adding and dropping the desired optical signal channels at the specific node in the optical transmission system for transmitting signals in bi-direction through one optical fiber, and in addition, even if the light proceeding in the opposite direction reflected and inputted due to Rayleigh Scattering and the connector reflection, the light can be removed by means of arrangement of the reflection type filters in the bi-directional optical add/drop multiplexer, thereby preventing the deterioration of the transmission efficiency.

### TECHNICAL FIELD

The present invention relates to a bi-directional optical add/drop multiplexer used in a bi-directional optical transmission system. More particularly, the present invention relates to a bi-directional optical transmission apparatus for adding and dropping optical signals in a bi-directional optical transmission system.

### BACKGROUND OF THE INVENTION

FIGS. 1a and 1b show a scheme of a bi-directional optical add/drop multiplexer in accordance with a conventional art. As shown in FIG. 1a, the bi-directional optical add/drop multiplexer comprises 110 and 120 which are two arrayed wave-guide grating (AWG), and a bi-directional switch 130. The bi-directional switch 130 comprises an optical amplifier 131 and two 2 by 2 switches 132, 133 as shown in FIG. 1b.

The operating procedure of the bi-directional optical add/drop multiplexer configured like this is following. The wavelength-multiplexed optical signals transmitted from the port P1 to the port P2 are demultiplexed by 110 and inputted to the bi-directional 2 by 2 switch 130. The wavelength-demultiplexed optical signals inputted to the switch 130 are inputted from the switch 132 to the switch 133. The optical signals transmitted to the switch 133 are dropped or added at the switch 133 or pass the switch 133. The optical signal channels passing the switch 133 are amplified by the optical amplifier 131, pass the switch 132 again and are inputted to 120 to be wavelength-multiplexed.

Because the conventional bi-directional optical add/drop multiplexer having this kind of properties should employ the expensive optical amplifiers for the respective channels, the cost of the system becomes high and thus the physical volume of the system becomes large, thereby causing the difficulty in view of control thereof.

Another conventional art with respect to the bi-directional optical add/drop multiplexer is described in the paper suggested by Y. Zhao et al., entitled to “A novel bi-directional Add/Drop Module using wave-guide grating routers and wavelength channel matched fiber gratings,” in IEEE Photonics Technology Letter, Vol. 11, No. 9, pp 1180-1182 published in 1999. This relates to the bi-directional optical add/drop multiplexer determining adding or dropping or passing of the optical signals by use of switches after performing the wavelength-demultiplexing of the inputted optical signals in the WGR (Waveguide Grating Router). However, because the WGR is employed in the conventional art, there is a problem that the optical noises such as cross talk due to the imperfection of the WGR occur in the channel.

### SUMMARY OF THE INVENTION

Therefore, in order to solve the above problems of the conventional art, an object of the present invention is to provide a bi-directional optical add/drop multiplexer comprising a circulator, a drop filter, an add filter, an optical isolator and an optical amplifier and being capable of dropping and adding optical signals at a specific node of a bi-directional optical transmission system. Also, other object of the present invention is to provide a bi-directional optical add/drop multiplexer capable of performing the dispersion compensation without the device for the dispersion compensation by use of the Chirped Fiber Bragg Grating device as a reflection type filter.

According to the present invention in order to accomplish the above objects, a bi-directional optical add/drop multiplexer which is used in an optical transmission system for bi-directionally transmitting a wavelength-multiplexed optical signal through an optical fiber, comprising: circulators for separating the wavelength-division-multiplexed optical signals transmitted in one direction and the wavelength-division-multiplexed optical signals transmitted in the opposite direction from each other; optical amplifiers for amplifying intensities of the wavelength-multiplexed optical signal separated by the circulators; drop filters for dropping the optical signals having the selected wavelength out of the wavelength-division-multiplexed optical signals received from the optical amplifiers; add filters for reflecting the optical signals having the non-selected wavelength passing the drop filters and for making the added optical signals transmitted in the opposite direction pass; and optical isolators for removing optical noises of the optical signals not reflected at the add filters out of the optical signals having the non-selected wavelength passing the optical droppers, is provided.

### BRIEF DESCRIPTION OF THE DRAWINGS

The embodiments of the present invention will be explained with reference to the accompanying drawings, in which:

FIG. 1a and FIG. 1b show a scheme of a bi-directional optical add/drop multiplexer in accordance with a conventional art;

FIG. 2 shows an entire scheme of a bi-directional optical add/drop multiplexer in accordance with a first embodiment of the present invention;

FIG. 3 shows in detail a scheme of the drop filter used in the bi-directional optical add/drop multiplexer in accordance with the first embodiment shown in FIG. 2;

FIG. 4 shows in detail a scheme of the drop filter used in the bi-directional optical add/drop multiplexer in accordance with a second embodiment;

FIG. 5 shows in detail a scheme of the drop filter used in the bi-directional optical add/drop multiplexer in accordance with a third embodiment;

FIG. 6 shows in detail a scheme of the add filter used in the bi-directional optical add/drop multiplexer in accordance with the first embodiment shown in FIG. 2;

FIG. 7 shows in detail a scheme of the drop filter used in the bi-directional optical add/drop multiplexer in accordance with a fourth embodiment;

FIG. 8 shows in detail a scheme of the drop filter used in the bi-directional optical add/drop multiplexer in accordance with a fifth embodiment; and

FIG. 9 shows in detail a scheme of the add filter used in the bi-directional optical add/drop multiplexer in accordance with a sixth embodiment.

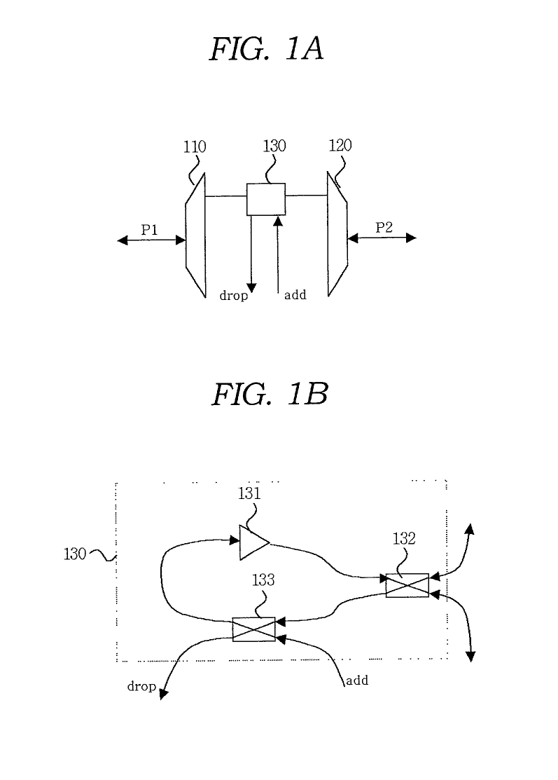

### DETAILED DESCRIPTION OF THE INVENTION

The above objects, other objects, features and advantages of the present invention will be better understood from the following description taken in conjunction with the drawings.

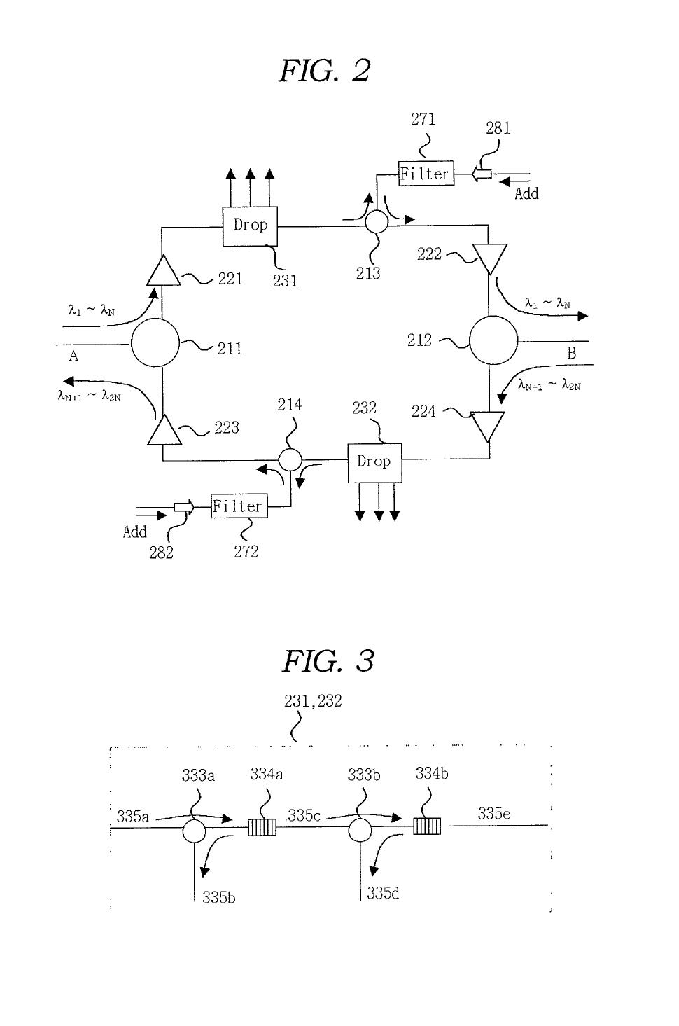

FIG. 2 is an entire scheme of a bi-directional optical add/drop multiplexer in accordance with the first embodiment of the present invention.

The bi-directional optical add/drop multiplexer according to this embodiment comprises circulators 211, 212, 213, 214, optical amplifiers 221, 222, 223, 224, drop filters 231, 232, add filters 271, 272 and optical isolators 281, 282.

The circulators 211, 212, 213, 214 that are optical elements having at least three ports output the wavelength-division-multiplexed optical signal inputted to a specific port to another specific port. The optical amplifiers 221, 222, 223, 224 amplify the intensity of the wavelength-division-multiplexed optical signals inputted from the circulators 211, 212, 213, 214. The drop filters 231, 232 drop the selected wavelength channels at a specific node out of the wavelength-division-multiplexed optical signals inputted from the optical amplifiers. The optical isolators 281, 282 transmit in only one direction the optical signals added to the optical isolators 281, 282. The add filters 271, 272 reflect the wavelength-division-multiplexed optical signals received from the drop filters 231, 232 to perform wavelength-division-multiplexing by way of making the added optical signals inputted through the optical isolators pass. The optical isolators 281, 282 play a role of removing the optical noises that are not reflected at the adding filters 271, 272.

The operating procedure of the bi-directional optical add/drop multiplexer configured like such is as following. The wavelength-division-multiplexed optical signals transmitted from the port A to the port B λ₁˜λ_{N} are separated from the optical signals transmitted from the port B to the port A during going through the first circulator 211 and then are inputted to the first optical amplifier 221. If the intensity of the optical signal is sufficient, the first optical amplifier can be omitted. After the intensities of the optical signals inputted to the first optical amplifier 221 are amplified, the optical signals are transmitted to the drop filter 231. The optical signals of the selected wavelength channel out of the optical signals inputted to the drop filter 231, are dropped selectively and the non-selected optical signals which have passed the drop filter 231 are inputted to the second circulator 213 and then inputted to the adding filter 271. The non-selected optical signals inputted to the add filter 271 are reflected at the add filter 271 and then inputted to the second circulator 213. The added optical signals are inputted to the second circulator 213 through the optical isolator 281 and the add filter 271 and thus are wavelength-division-multiplexed with the non-selected optical signals reflected at the add filter 271. The wavelength-division-multiplexed optical signals λ₁˜λ_{N} outputted from the second circulator 213 proceed to the port B through the third circulator 212 after the intensities of the optical signals are amplified at the optical amplifier 222.

At that time, the optical noises dumped from the reflection of the oppositely transmitted optical signals or line amplifiers, which pass the drop filter 231 and the second circulator 213, are not reflected from the add filter 271 and are removed by the optical isolator 281, thereby not being inputted to the optical amplifier 222.

The drop filter used in the optical add/drop multiplexer shown in FIG. 2 is shown in detail in FIG. 3. As shown in FIG. 3, in the case where the adding and dropping channels are fixed in the drop filter according to the present embodiment, the drop filter consists of the circulator and the Fiber Bragg Grating or the reflection type filter reflecting the optical signals having a specific wavelength. The Chirped Fiber Bragg Grating can be used for compensating the dispersion instead of usual Fiber Bragg Grating.

The operating procedure of the drop filter constructed like such is as following. The wavelength-division-multiplexed optical signals transmitted from the port 335a to the port 335e are inputted to the first reflection type filter through the circulator 333a. Out of the inputted optical signals, only the optical signal having the first selected wavelength are reflected at the first reflection type filter and the optical signals having the non-selected wavelength go through the first reflection type filter. The optical signals reflected at the first reflection type filter 334a proceed to the port 335b through the circulator 335b. On the other the hand, the wavelength-division-multiplexed optical signals having the non-selected wavelength going through the first reflection type filter 334a are inputted to the second reflection type filter which reflects the optical signals having the second selected wavelength different from the first selected wavelength through the circulator 333b. Out of the inputted optical signals, the optical signals having the second selected wavelength are reflected at the second reflection type filter and proceed to the port 335d through the circulator 333b. The wavelength-division-multiplexed optical signals except for the optical signals having the first and second selected wavelength proceed to the port 335e.

So, when the optical signals having other wavelength are to be dropped, the channel drop filter consisting of a pair of a circulator and a reflection type filter can be further included.

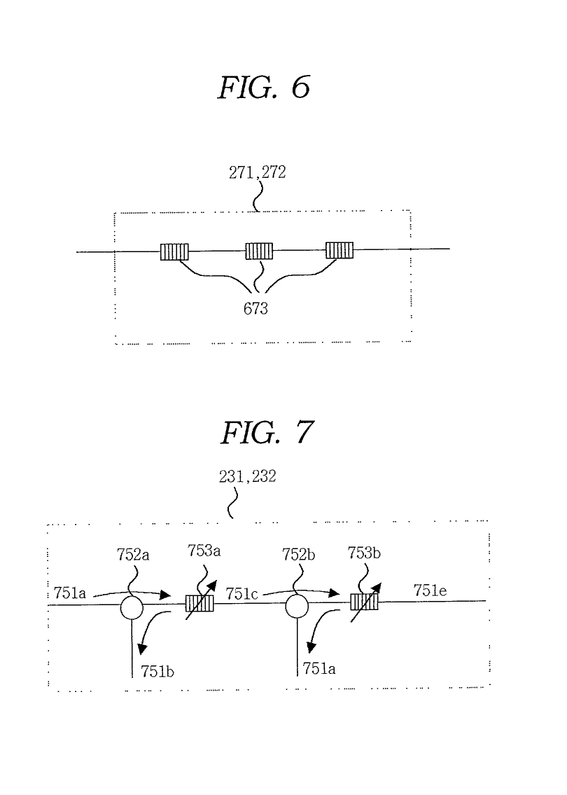

FIG. 6 shows in detail a scheme of the add filter used in the bi-directional optical add/drop multiplexer in accordance with the first embodiment shown in FIG. 2. As shown in FIG. 6, the add filter in accordance with this embodiment includes a reflection type filter connected to each other in series, in the case where the drop and add channels are fixed. At that time, the Chirped Fiber Bragg Grating element can be used for dispersion compensation.

As shown in drawings, the reflection type filters 673 connected in series reflect the optical signals having the selected wavelength different from each other. In the case where the multiplexed N wavelengths are inputted and m wavelengths are dropped at the drop filter, the reflection type filter consists of the reflection filters corresponding to N-m wavelengths.

FIG. 4 shows in detail another scheme of the drop filter used in the bi-directional optical add/drop multiplexer in accordance with the second embodiment of the present invention. The construction of the optical dropper in accordance with the second embodiment is equal to that in accordance with the first embodiment, except for that of the optical dropper, and thus the equal constructions will not be explained. The drop filters used in the optical add/drop multiplexer in accordance with the second embodiment include one circulator and a plurality of reflection type filters corresponding to the dropped wavelength, in the case where the drop and add channels are fixed. The Chirped Fiber Bragg Grating element can be used for dispersion compensation as the reflection type filter.

The operating procedure of the drop filters constructed like such is as following. The optical signals transmitted from the port 436a to the port 436b are inputted to the first reflection type filter through the circulator 437. Out of the inputted optical signals, only the optical signal having the selected wavelength are reflected at the first reflection type filter 438a and the optical signals having the non-selected wavelength pass the first reflection type filter. The reflected optical signals having the selected wavelength proceed to the port 436b through the circulator 433a. On the other the hand, the optical signals having the non-selected wavelength passing the first reflection type filter 438a are inputted to the second reflection type filter 438b which reflects the optical signals having the second selected wavelength different from the first selected wavelength. The optical signals having the second selected wavelength, out of the inputted optical signals, are reflected at the second reflection type filter. The reflected optical signals proceed to the port 436b through the first reflection type filter 438a and the circulator 437.

So, when the optical signals having other wavelength are to be dropped, a reflection type filter reflecting the corresponding wavelength can be further included.

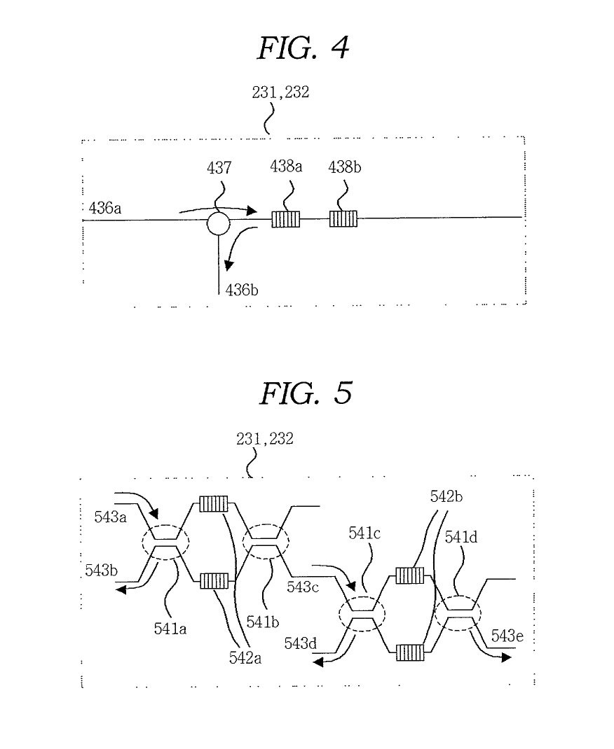

FIG. 5 shows in detail the other scheme of the drop filter used in the bi-directional optical add/drop multiplexer in accordance with the third embodiment of the present invention. The construction of the optical drop/add multiplexer in accordance with the third embodiment is equal to that of the optical drop/add multiplexer in accordance with the first embodiment, except for that of the drop filter and thus the equal constructions will not be explained. The drop filter used in the optical add/drop multiplexer in accordance with the third embodiment include two 3 dB couplers and two reflection type filters reflecting the same wavelength, in the case where the drop and add channels are fixed. The Chirped Fiber Bragg Grating element can be used for dispersion compensation as the reflection type filter.

The operating procedure of the drop filter constructed like such is as following. The wavelength-division-multiplexed optical signals inputted to the port 543a are divided at the 3 dB coupler 541a and inputted to two identical reflection type filters, respectively. The two reflection type filters reflect only the optical signals having the selected wavelength out of the inputted optical signals. The reflected optical signals having the selected wavelength are made to proceed to the port 543b due to the interference of the optical signals from the reflection type filters 542a. On the other the hand, the optical signals having the non-selected wavelength passing the two identical reflection type filters 542a are inputted to the other 3 db coupler 441b. As described above, the optical dropper consisting of two identical reflecting filters and two 3 db couplers is a drop filter for dropping only one selected wavelength. As shown in FIG. 5, in order to drop other wavelengths to another port, the single channel drop filters can be added serially.

FIG. 7 shows in detail a scheme of the drop filter used in the tunable bi-directional optical add/drop multiplexer in accordance with the fourth embodiment of the present invention. The construction of the optical drop/add multiplexer in accordance with the fourth embodiment is equal to that of the optical drop/add multiplexer in accordance with the first embodiment, except for that of the drop filter and thus the equal constructions will not be explained. The drop filter used in the optical add/drop multiplexer in accordance with the fourth embodiment include a circulator and a tunable filter, in the case that the drop and add channels of the optical signals are selective. The Chirped Fiber Bragg Grating element can be used for dispersion compensation as the reflection type filter.

The operating procedure of the drop filter constructed like such is as following. In the case that the optical signals of three selected wavelengths, λ1, λ2 and λ3 proceed, the first tunable filter 753a selects and drops the optical signals having the wavelength λ1 and λ2 out of the inputted optical signals by way of adjusting the first and second tunable filter so that the first tunable filter reflects the optical signal of λ1 and the second tunable filter reflects the optical signal of λ2. If only the optical signal of λ1 is to be dropped, the first and second tunable filter can be adjusted so that one of the first and second tunable filters reflects only the optical signal of λ1 and the other makes all the optical signals of the λ1, λ2 and λ3 pass.

Like this, the drop filter in the tunable optical add/drop multiplexer that the add and drop channels are selective needs n tunable filters, if at most n optical signals are to be selected and dropped when N wavelength-multiplexed optical signals are transmitted in one direction.

FIG. 8 shows in detail another scheme of the drop filter used in the tunable bi-directional optical add/drop multiplexer in accordance with the fifth embodiment. The construction of the optical drop/add multiplexer in accordance with the fifth embodiment is equal to that of the optical drop/add multiplexer in accordance with the first embodiment, except for that of the drop filters and add filters and thus the equal constructions will not be explained. The drop filter used in the optical add/drop multiplexer in accordance with the fifth embodiment include a circulator and a tunable filter connected in series, in the case that the drop and add channels of the optical signals can be controlled remotely. The Chirped Fiber Bragg Grating can be used for dispersion compensation as the reflection type filter.

The operating procedure of the drop filter constructed like such is equal to the operating procedure of the drop filter shown in FIG. 7 and thus will be omitted.

If at most n optical signals are to be selectively dropped when the N wavelength-multiplexed optical signals are transmitted in one direction, n tunable filters are required. At that time, the selection of the wavelength to be dropped can be carried out by way of adjusting the reflected wavelength of the tunable filter to the desired wavelength.

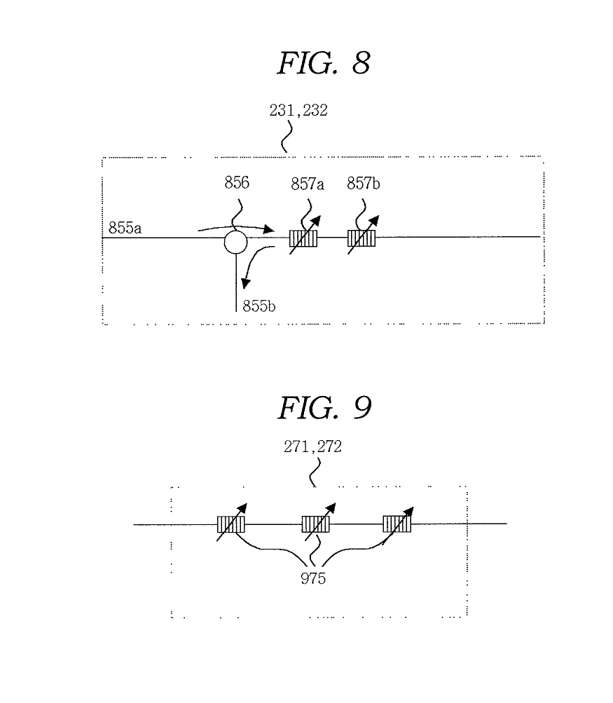

FIG. 9 shows in detail a scheme of the add filter used in the tunable bi-directional optical add/drop multiplexer in accordance with the forth and fifth embodiment. The construction of the optical drop/add multiplexer in accordance with the forth and fifth embodiment is equal to that of the optical drop/add multiplexer in accordance with the first embodiment, except for that of the add filter and drop filter and thus the equal constructions will not be explained. The add filter used in the optical add/drop multiplexer in accordance with the forth and fifth embodiment consists of tunable filters connected in series, in the case that the drop and add channels of the optical signals can be controlled remotely. The Chirped Fiber Bragg Grating can be used for dispersion compensation as the tunable filter.

If at most n optical signals are to be selectively dropped when the N wavelength-multiplexed optical signals are transmitted in one direction, N tunable reflection type filters are required.

According to the aforementioned present invention, the optical signal having the wanted wavelength can be dropped from and added to a specific node, in a bi-directional optical transmission system for transmitting signals in bi-direction through one optical fiber. Also, even if the reflection at the reflection type filter is not complete, the leakage affecting the performance of the optical transmission device can be prevented. In addition, even if light proceeding in the opposite direction is inputted, the light can be removed by means of arrangement of the reflection type filters in the bi-directional optical add/drop multiplexer, so that deterioration of the transmission efficiency can be prevented.

Although technical spirits of the present invention has been disclosed with reference to the appended drawings and the preferred embodiments of the present invention corresponding to the drawings has been described, descriptions in the present specification are only for illustrative purpose, not for limiting the present invention.

Also, those who are skilled in the art will appreciate that various modifications, additions and substitutions are possible without departing from the scope and spirit of the present invention. Therefore, it should be understood that the present invention is limited only to the accompanying claims and the equivalents thereof, and includes the aforementioned modifications, additions and substitutions.

What is claimed is:

1. A bi-directional optical add/drop multiplexer which is used in an optical transmission system for bi-directionally transmitting a wavelength-division-multiplexed optical signal through an optical fiber, comprising:
circulators for separating the wavelength-division-multiplexed optical signals transmitted in one direction and the wavelength-division-multiplexed optical signals transmitted in the opposite direction from each other;
optical amplifiers for amplifying intensities of the wavelength-division-multiplexed optical signals separated by the circulators;
drop filters for dropping the optical signals having a selected wavelength out of the wavelength-division-multiplexed optical signals received from the optical amplifiers;
add filters for reflecting the optical signals having a non-selected wavelength passing the drop filters and for making the added optical signals transmitted in the opposite direction pass; and
optical isolators for removing optical noises of the optical signals not reflected at the adding filters out of the optical signals having the non-selected wavelength passing the drop filters.

2. A bi-directional optical add/drop multiplexer according to claim 1, wherein the add filters consist of a Chirped Fiber Bragg Grating element for dispersion compensation.

3. A bi-directional optical add/drop multiplexer according to claim 1, wherein the drop filters drop the optical signals having the selected wavelength by use of the circulators and the reflection type filters.

4. A bi-directional optical add/drop multiplexer according to claim 1, wherein the drop filters drop the optical signals having the selected wavelength by use of one circulator and a plurality of reflection type filters connected with the circulator in series.

5. A bi-directional optical add/drop multiplexer according to claim 1, wherein the drop filters consist of two 3 dB couplers and two identical reflection type filters for reflecting the optical signals having the same selected wavelength and drop one channel of the optical signals.

6. A bi-directional optical add/drop multiplexer according to claim 1, wherein the drop filters drop the optical signals having the desired selected wavelength out of the wavelengths of the optical signals by use of one circulator and a plurality of tunable filters.

7. A bi-directional optical add/drop multiplexer according to claim 6, wherein the tunable filters consist of a Fiber Bragg Grating and/or the reflection type filters.

8. A bi-directional optical add/drop multiplexer according to claim 1, wherein the add filters are constructed by way of connecting a plurality of the reflection type filters in series, reflect the optical signals having the selected wavelength going through nodes and make the optical signals having the non-selected wavelength pass.

9. A bi-directional optical add/drop multiplexer according to claim 1, wherein the add filters are constructed by way of a plurality of tunable filters.
